(19) United States
(12) Patent Application Publication
(10) Pub. No.: US 2005/0283466 A1
(43) Pub. Date: Dec. 22, 2005

(54) Techniques for creating queries

(75) Inventors: Richard D. Dettinger, Rochester, MN (US); Daniel P. Kolz, Rochester, MN (US); Jeffrey W. Tenner, Rochester, MN (US); Shannon E. Wenzel, Colby, WI (US)

Correspondence Address: IBM CORPORATION;ROCHESTER IP LAW DEPT. 917, 3605 HIGHWAY 52 NORTH, ROCHESTER, MN, 55901-7829, US

(73) Assignee: International Business Machines Corporation, Armonk, NY (US)

(21) Appl. No.: 10/870,379

(22) Filed: Jun. 17, 2004

(51) Int. Cl. G06F 17/30

(52) U.S. Cl. 707/3; 707/2

(57) ABSTRACT

A method, system and article of manufacture for creating queries and, more particularly, for creating queries using query conditions from previously defined queries. One embodiment provides a method for composing a query. The method comprises displaying at least a first query object representative of a first query and a second query object representative of a second query in a user interface. Each of the query objects is positionally related to define a plurality of user-selectable regions. Each region corresponds to a different executable query.

### CROSS-REFERENCE TO RELATED APPLICATIONS

This application is related to commonly owned, co-pending U.S. patent application Ser. No. 10/083,075, entitled “Application Portability And Extensibility Through Database Schema And Query Abstraction,” filed February 26, 2002, which is incorporated by reference in its entirety.

### BACKGROUND OF THE INVENTION

1. Field of the Invention

The present invention generally relates to data processing and, more particularly, to creating queries using query conditions from previously defined queries.

2. Description of the Related Art

Databases are computerized information storage and retrieval systems. A relational database management system is a computer database management system (DBMS) that uses relational techniques for storing and retrieving data. The most prevalent type of database is the relational database, a tabular database in which data is defined so that it can be reorganized and accessed in a number of different ways. A distributed database is one that can be dispersed or replicated among different points in a network. An object-oriented programming database is one that is congruent with the data defined in object classes and subclasses.

Regardless of the particular architecture, a DBMS can be structured to support a variety of different types of operations. Such operations can be configured to retrieve, add, modify and delete information being stored and managed by the DBMS. Standard database access methods support these operations using high-level query languages, such as the Structured Query Language (SQL). The term “query” denominates a set of commands that cause execution of operations for processing data from a stored database. For instance, SQL supports four types of query operations, i.e., SELECT, INSERT, UPDATE and DELETE. A SELECT operation retrieves data from a database, an INSERT operation adds new data to a database, an UPDATE operation modifies data in a database and a DELETE operation removes data from a database.

Any requesting entity, including applications, operating systems and, at the highest level, users, can issue queries against data in a database. Queries may be predefined (i.e., hard coded as part of an application) or may be generated in response to input (e.g., user input). Upon execution of a query against a database, a query result is returned to the requesting entity. For instance, assume a user who performs statistical analyses in a hospital to determine information about individuals belonging to a first group of patients and individuals belonging to a second group of patients. To this end, the user issues a first query to determine the information about the individuals belonging to the first group and a second query to determine the information about the individuals belonging to the second group. The first and second queries are executed against one or more databases having the required information. For each query that is executed, a query result is obtained that defines a given set of individuals. Accordingly, the user may execute multiple queries selecting many different sets of individuals. Furthermore, the user may persistently store any executed query and corresponding result sets. Thus, the user may frequently execute stored queries to determine whether new records have been stored in the database(s) since a previous execution of the queries.

Assume now that the user would like to determine individuals in the hospital which belong to more than one group of patients. In other words, the user may want to determine intersections of different result sets. For instance, the user has executed the first query to determine patients living in Minnesota that suffer from Parkinson's disease and are between the ages of 50 and 60 years. Furthermore, the user has executed the second query to determine patients that suffer from Alzheimer's disease or are treated for a prescribed drug X. Now the user wants to determine all patients living in Minnesota that suffer from Parkinson's disease, are between the ages of 50 and 60 years, and suffer from Alzheimer's disease or are treated for a prescribed drug X. To this end, the user needs to create a third query by analyzing and combining associated query conditions of the first and second queries. However, the process of combining the query conditions is error prone, time consuming, and complex. In the case of complex queries, analyzing the query conditions of the first and second queries to understand the mechanics of the query conditions of both queries is a particularly tedious process.

Therefore, there is a need for an efficient technique for creating queries using query conditions from previously defined queries.

### SUMMARY OF THE INVENTION

The present invention is generally directed to a method, system and article of manufacture for creating queries and, more particularly, for creating queries using query conditions from previously defined queries.

One embodiment provides a method for composing a query. The method comprises displaying at least a first query object representative of a first query and a second query object representative of a second query in a user interface. Each of the query objects is positionally related to define a plurality of user-selectable regions. Each region corresponds to a different executable query.

Another embodiment of a method for composing a query comprises displaying, in a user interface, at least a first graphical object and a second graphical object. Each graphical object is representative of a different query. Each of the graphical objects is positionally related so that respective portions of the graphical objects are overlapping one another, whereby a plurality of user-selectable regions is defined. The plurality of user-selectable regions comprises (i) an overlapping region defined by the overlapping respective portions and (ii) non-overlapping regions defined by the non-overlapping portions of the graphical objects. Each user-selectable region corresponds to a different executable query.

Still another embodiment provides a computer-readable medium containing a program which, when executed by a processor, performs a process for composing a query. The process comprises displaying at least a first query object representative of a first query and a second query object representative of a second query in a user interface. Each of the query objects is positionally related to define a plurality of user-selectable regions. Each region corresponds to a different executable query.

Still another embodiment provides a computer-readable medium containing a program which, when executed by a processor, performs another process for composing a query. The process comprises displaying, in a user interface, at least a first graphical object and a second graphical object. Each graphical object is representative of a different query. Each of the graphical objects is positionally related so that respective portions of the graphical objects are overlapping one another, whereby a plurality of user-selectable regions is defined. The plurality of user-selectable regions comprises (i) an overlapping region defined by the overlapping respective portions and (ii) non-overlapping regions defined by the non-overlapping portions of the graphical objects. Each user-selectable region corresponds to a different executable query.

Yet another embodiment provides a graphical user interface residing in computer readable medium and configured for displaying a query composition user interface comprising a query representation display area. The query representation display area is configured for displaying at least a first graphical object and a second graphical object. Each graphical object is representative of a different query. The graphical objects are positionally related so that respective portions of the graphical objects are overlapping one another, whereby a plurality of user-selectable regions is defined. The plurality of user-selectable regions comprises (i) an overlapping region defined by the overlapping respective portions and (ii) non-overlapping regions defined by the non-overlapping portions of the graphical objects. Each user-selectable region corresponds to a different executable query.

Yet another embodiment provides a graphical user interface residing in computer readable medium and configured for displaying a Venn diagram display area. The Venn diagram display area allows users to manipulate at least a first geometrically shaped object representative of a first query and a second geometrically shaped object representative of a second query. The objects are positionally related by user manipulation to define a plurality of user-selectable regions. Each region corresponds to a different executable query.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a relational view of software components in one embodiment;

FIG. 2 is a flow chart illustrating a method for managing creation of a query in one embodiment; and

FIGS. 3-8 are illustrative user interfaces for creating queries in one embodiment.

### DETAILED DESCRIPTION OF THE PREFERRED EMBODIMENTS

Introduction

The present invention is generally directed to a method, system and article of manufacture for creating queries and, more particularly, for composing a query using previously defined queries. According to one aspect, a query can be composed graphically by combining graphical representations of previously defined queries. To this end, the graphical representations can be displayed in a diagram representing queryable data. The graphical representations can be arranged by a user to form user-selectable regions. Thus, as used herein, a “user-selectable region” is a bounded region defined by the graphical representations, rather than a region that a user defines. Each user-selectable region corresponds to an executable query against the queryable data. The query conditions of each executable query can be determined by combining the query conditions of at least a portion of the previously defined queries.

In one embodiment, a query can be composed using a graphical user interface having a query selection display area and a query representation display area. The query selection display area is configured for displaying a plurality of user-selectable queries. Using the query selection display area, a user can select one or more queries from the plurality of user-selectable queries. For each selected query, a graphical object is displayed in the query representation display area. Each graphical object is representative of a corresponding user-selectable query and, consequently, of an associated query result. Thus, the query representation display area schematically represents relationships between the associated query results. According to one aspect, the query representation display area represents a Venn diagram and the graphical objects are circles. The graphical objects are positionally related so that respective portions of the graphical objects are overlapping one another, thereby defining a plurality of user-selectable regions. The plurality of user-selectable regions comprises (i) an overlapping region defined by the overlapping respective portions and (ii) non-overlapping regions defined by the non-overlapping portions of the graphical objects. Each region corresponds to a different executable query. Thus, in response to selection of one of the user-selectable regions by the user, a corresponding executable query can be created for execution against one or more databases. In addition, two or more user-selected regions can be combined to produce a singular resultant query or two independent queries that are unioned.

Data Processing Environment

One embodiment of the invention is implemented as a program product for use with a computer system. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The software of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular nomenclature that follows is used merely for convenience, and thus the invention should not be limited to use solely in any specific application identified and/or implied by such nomenclature.

Embodiments of the invention can be implemented in a hardware/software configuration including at least one networked client computer and at least one server computer. Furthermore, embodiments of the present invention can apply to any comparable hardware configuration, regardless of whether the computer systems are complicated, multi-user computing apparatus, single-user workstations, or network appliances that do not have non-volatile storage of their own. Further, it is understood that while reference may be made to particular query languages, including SQL, the invention is not limited to a particular language, standard or version. Accordingly, persons skilled in the art will recognize that the invention is adaptable to other query languages and that the invention is also adaptable to future changes in a particular query language as well as to other query languages presently unknown.

Preferred Embodiments

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and, unless explicitly present, are not considered elements or limitations of the appended claims.

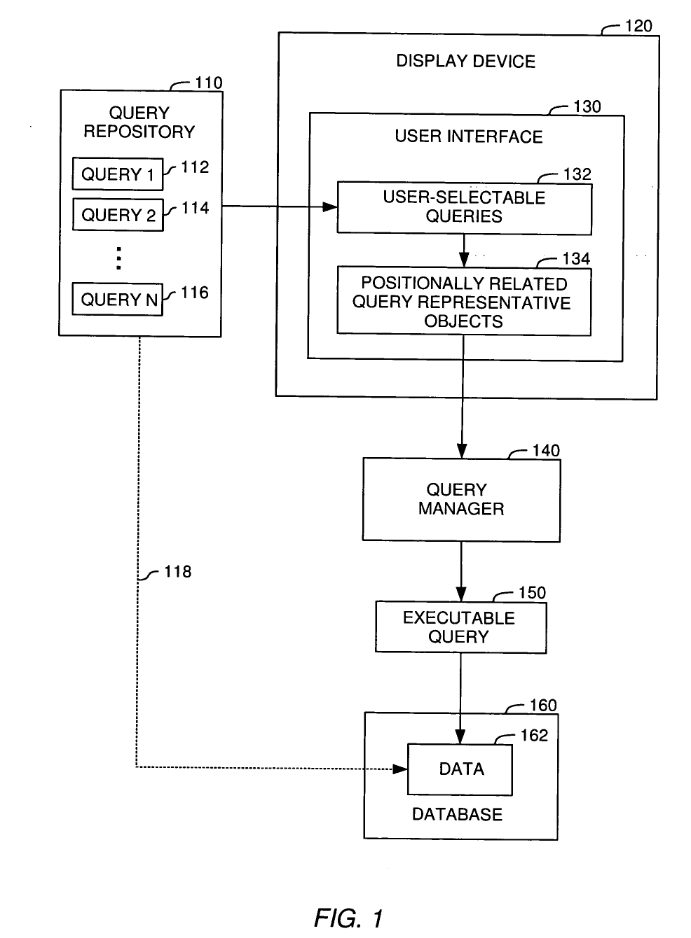

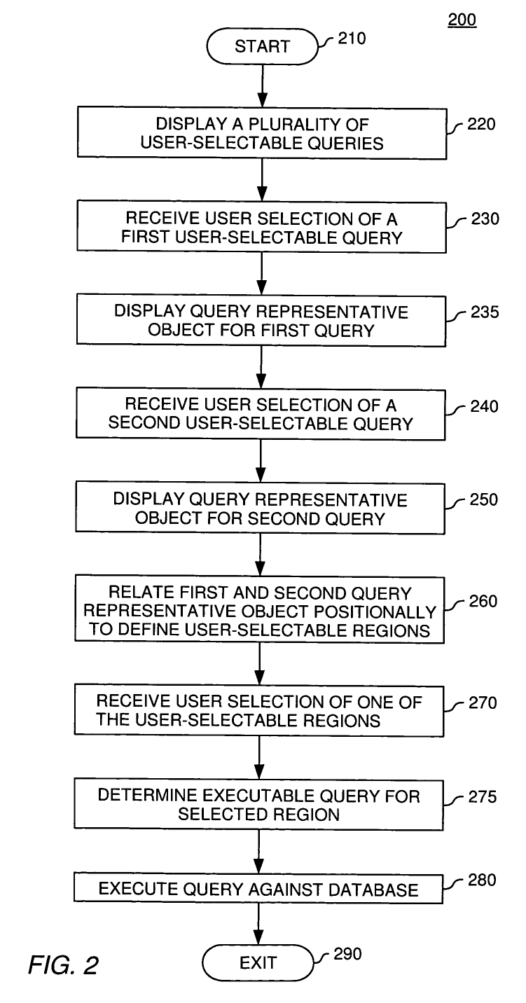

Referring now to FIG. 1, a relational view of software components in one embodiment is illustrated. The software components illustratively include a query repository 110, a user interface 130, a query manager 140 and a database 160. According to one aspect, the user interface 130 is configured for graphically constructing queries. An exemplary method illustrating construction of a query using the user interface 130 is described below with reference to FIG. 2.

Illustratively, the query repository 110 includes a plurality of previously defined queries 112, 114 and 116. However, providing the query repository 110 with the previously defined queries 112, 114 and 116 is merely illustrative and not intended for limiting the invention accordingly. Instead, the previously defined queries 112, 114 and 116 may be provided separately from each other and stored individually at different locations in a corresponding data processing system. Further, the queries 112, 114 and 116 may be output by different applications, or may be generated in response to input (e.g., user input). In one embodiment, the queries 112, 114 and 116 are not predefined in the sense of being persistent objects in the query repository 110, but are instead composed and displayed in the user interface 130 during a given user session.

The queries 112, 114 and 116 are defined for execution against data 162 in the database 160 as illustrated by dashed arrow 118. The database 160 is representative of any collection of data regardless of the particular physical representation. For example, the data 162 may represent tables (and their respective contents) defined by columns and rows. By way of illustration, the database 160 may be organized according to a relational schema (accessible by SQL queries) or according to an XML schema (accessible by XML queries). However, the invention is not limited to a particular physical representation or schema and contemplates extension to schemas presently unknown. As used herein, the term “schema” generically refers to a particular arrangement of the data 162.

According to one aspect, the queries 112, 114 and 116 are abstract queries. An abstract query is composed using logical fields defined by a data abstraction model. Each logical field is mapped to one or more physical entities of data of an underlying data representation being used in the data source 160 (e.g., XML, SQL, or other type representation). Furthermore, in the data abstraction model the logical fields are defined independently from the underlying data representation, thereby allowing queries to be formed that are loosely coupled to the underlying data representation. The abstract query can be configured to access the data 162 and return query results, or to modify (i.e., insert, delete or update) the data 162. For execution against the data 162, the abstract query is transformed into a form (referred to herein as concrete query) consistent with the underlying data representation of the data 162. Transformation of abstract queries into concrete queries is described in detail in the commonly owned, co-pending U.S. patent application Ser. No. 10/083,075, entitled “Application Portability And Extensibility Through Database Schema And Query Abstraction,” filed Feb. 26, 2002, which is incorporated by reference in its entirety.

In one embodiment, the user interface 130 is displayed on a display device 120 and includes (i) a query selection display area 132 (hereinafter referred to as “selection area”, for brevity) for displaying one or more user-selectable queries and (ii) a query representation display area 134 (hereinafter referred to as “representation area”, for brevity) for displaying positionally related graphical objects. Each user-selectable query displayed in the selection area 132 corresponds to a query, e.g., one of the queries 112, 114 and 116 from the query repository 110. For each selected user-selectable query from the one or more user-selectable queries, a graphical object representative of the selected query is displayed in the representation area 134. By way of example, the representation area 134 illustrates a Venn diagram and the graphical object is a circle, although any other shape is contemplated.

The graphical objects are positionally related in the representation area 134 so that respective portions of the graphical objects are overlapping one another. Accordingly, the positionally related graphical objects define a plurality of user-selectable regions. The plurality of user-selectable regions comprises (i) an overlapping region defined by the overlapping respective portions; (ii) non-overlapping regions defined by the non-overlapping portions of the graphical objects; and (iii) an unoccupied region (i.e., the region not occupied by any portion of the selected queries (graphical objects) in the representation area 134). Each region corresponds to a different executable query.

Using the user interface 130, a user can select one of the user-selectable regions for creation of a given executable query. In one embodiment, in response to selection of one of the user-selectable regions by the user, a corresponding executable query 150 is created by the query manager 140 for execution against the data 162 in the database 160. Creation of a query using the user interface 130 and the query manager 140 is explained in more detail below with reference to FIGS. 2-8.

Referring now to FIG. 2, one embodiment of a method 200 for creating a query using previously defined queries is shown. At least part of the steps of method 200 can be performed using a user interface (e.g., user interface 130 of FIG. 1) and/or a query manager (e.g., query manager 140 of FIG. 1). Method 200 starts at step 210.

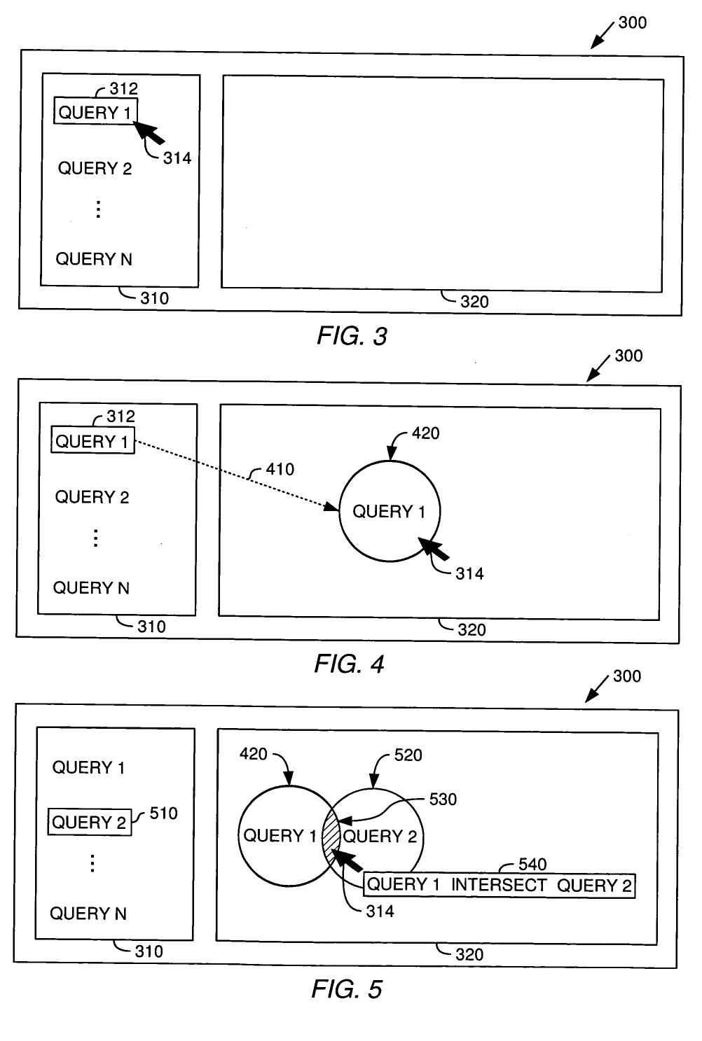

At step 220, a plurality of user-selectable queries is displayed. For instance, the user-selectable queries are displayed in a selection area of the user interface (e.g., selection area 132 of FIG. 1). At step 230, a user selection of a first query from the user-selectable queries is received. An exemplary user interface illustrating selection of a first query is described below with reference to FIG. 3.

At step 235, a first graphical object representative of the first query is displayed. By way of example, the first graphical object is displayed in the representation area 134 of FIG. 1. An exemplary user interface illustrating display of a first graphical object is described below with reference to FIG. 4.

At step 240, a user selection of a second query from the user-selectable queries is received. At step 250, a second graphical object representative of the second query is displayed together with the first graphical object. An exemplary user interface illustrating selection and display of a second graphical object is described below with reference to FIG. 5.

At step 260, the first and second graphical objects are positionally related to define a plurality of user-selectable regions. Each region corresponds to a different executable query. Exemplary user interfaces illustrating different user-selectable regions are described below with reference to FIGS. 5-8.

In one embodiment, positionally relating the first and second graphical objects is performed in response to user input. Alternatively, the graphical objects can be related positionally according to predefined user settings without user intervention. For instance, the graphical objects can be related positionally such that each graphical object defines an overlapping portion with each other graphical object or with at least one other graphical object.

At step 270, a user selection of one of the user-selectable regions is received. At step 275, an executable query corresponding to the selected region is determined. Selection of a user-selectable region and determination of the executable query is described in more detail below with reference to FIGS. 5-7, by way of example. In one embodiment, the executable query can be stored persistently. For instance, the executable query can be stored in the query repository 110 of FIG. 1 and thus becomes one of predefined defined queries 112, 114 and 116 available for selection. Furthermore, execution of the executable query can be scheduled according to user preferences.

At step 280, the executable query is executed against one or more databases (e.g., database 160 of FIG. 1). Method 200 then exits at step 290.

Referring now to FIG. 3, an illustrative user interface 300 is shown. By way of example, the user interface 300 includes a selection area 310 (e.g., selection area 132 of FIG. 1) and a representation area 320 (e.g., representation area 134 of FIG. 1). The representation area 320 is configured for displaying graphical objects representative of selected queries. The selection area 310 is configured for displaying a plurality of user-selectable queries (e.g., queries 112-116 of FIG. 1). The selection area 310 is further configured for allowing users to select queries from the displayed plurality of user-selectable queries. To select a query, a user may use any suitable input device, such as a keyboard or a pointing device. By way of example, a mouse cursor 314 (hereinafter referred to as cursor) is shown at a position over a query 312 “QUERY 1”. In one embodiment, the cursor 314 is positioned over the query 312 “QUERY 1” in response to user manipulation of a pointing device, such as a computer mouse, a light pen, or even a human finger in the case of a touch screen. For the following explanations, it is assumed that the user uses a computer mouse for moving and positioning the cursor 314 in the user interface 300.

Illustratively, the user selects the query 312 “QUERY 1” using the computer mouse. Referring now to FIG. 4, the illustrative user interface 300 is shown after selection of the query 312 “QUERY 1”. Illustratively, the user interface 300 includes a graphical object 420 representative of the selected query 312 “QUERY 1”. The graphical object 420 is displayed in the representation area 320. In one embodiment, the graphical object 420 is displayed in response to a drag-and-drop operation on the selected query 312 “QUERY 1”. More specifically, as illustrated in FIG. 3, the user can position the cursor 314 over the user-selectable query 312 “QUERY 1”. The user may then push the left mouse button, for instance, to select the query 312 “QUERY 1” and drag the selected query 312 “QUERY 1” to the representation area 320 (as illustrated by dashed arrow 410). Then, the user may drop the selected query 312 “QUERY 1” on the representation area 320 to cause creation and display of the graphical object 420. Subsequently, the user can select one or more other queries from the user-selectable queries, as illustrated in FIG. 5.

Referring now to FIG. 5, the illustrative user interface 300 is shown after selection of another query, i.e., query 510 “QUERY 2” from the selection area 310. Accordingly, a graphical object 520 representative of the selected query 510 “QUERY 2” is displayed in the representation area 320 together with the graphical object 420.

According to one aspect, the representation area 320 defines a Venn diagram, wherein the graphical objects 420 and 520 are circles of equal sizes. However, it should be noted that any geometrically shaped graphical object is broadly contemplated, such as rectangles or triangles. Furthermore, the graphical objects may have different sizes to indicate corresponding sizes of query results obtained for the selected queries. Moreover, the representation area 320 can be any suitable schematic diagram illustrating relationships between different graphical objects representative of corresponding queries. Specifically, the representation area 320 can be any diagram allowing the user to positionally relate different graphical objects.

By way of example, the graphical objects 420 and 520 are positionally related so that respective portions of the graphical objects 420 and 520 are overlapping one another. Accordingly, the positionally related graphical objects 420 and 520 define an overlapping region, and non-overlapping regions defined by the non-overlapping portions of the graphical objects 420 and 520 and the unoccupied region in the representation area 320. Each defined region is user-selectable and corresponds to an executable query. By way of example, using the representation area 320 of FIG. 5 which includes the graphical objects 420 and 520, fourteen different user-selectable regions are defined. In other words, using the representation area 320, fourteen different queries can be created, as illustrated in the following with reference to FIGS. 5-8.

In one embodiment, when the cursor 314 hovers over one of the user-selectable regions, a hover text message is displayed proximate the cursor 314. The hover text message describes the executable query corresponding to the user-selectable region. Illustratively, the cursor 314 is positioned over a user-selectable region 530 defined by the overlapping region of the graphical objects 420 and 520. Accordingly, a hover text message 540 describing the executable query corresponding to the user-selectable region 530 is displayed. In the given example the user-selectable region 530 is a geometrical intersection of the graphical objects 420 and 520. Thus, the hover text message 540 may include descriptive language indicating that the executable query represents an intersection of the selected queries “QUERY 1” and “QUERY 2” corresponding to the graphical objects 420 and 520, respectively. In a particular embodiment, the hover text message is query language (e.g., SQL) corresponding to the executable query.

The user can select the user-selectable region 530 for execution of the executable query against data (e.g., data 162 of FIG. 1) of one or more databases (e.g., database 160 of FIG. 1). For instance, if “QUERY 1” is configured to determine all patients in a hospital that suffer from Parkinson's disease and “QUERY 2” is configured to determine all patients in the hospital that suffer from Alzheimer's disease, the user may wish to determine all patients in the hospital that suffer from Parkinson's and Alzheimer's disease. To this end, the user may click on the user-selectable region 530 using the computer mouse. In one embodiment, the selected region 530 is highlighted as feedback to the user in response to a selection thereof. Illustratively, the selected region 530 is hatched.

In response to selection of the region 530, the executable query is determined. More specifically, each of the selected queries “QUERY 1” and “QUERY 2” may include a plurality of query conditions specifying selection criteria for data to be returned. The query conditions are logically combined by Boolean operators, such as Boolean AND and/or OR operators. In the given example, the query conditions of the executable query are defined by the intersection of the query conditions of the selected queries “QUERY 1” and “QUERY 2”. Therefore, the query conditions of the selected queries “QUERY 1” and “QUERY 2” must be logically combined using an AND operator to determine the intersection thereof. In other words, the query conditions of the executable query could be logically defined by:
(Query conditions of QUERY 1) AND (Query conditions of QUERY 2)
   Through a process of Boolean algebra, these query conditions may then be simplified.

In one embodiment, the selected queries “QUERY 1” and “QUERY 2” are SQL queries. Accordingly, the intersection of the selected queries “QUERY 1” and “QUERY 2” can be determined using the INTERSECT statement of the SQL set operations. In other words, in SQL the executable query can be expressed as:
(QUERY 1) INTERSECT (QUERY 2)

The INTERSECT statement is used to merge query results obtained for the selected queries “QUERY 1” and “QUERY 2” into a single query result. Therefore, the structure of the individual query results of the selected queries “QUERY 1” and “QUERY 2” must be compatible. However, the selected queries “QUERY 1” and “QUERY 2” may return query results having different data elements. For instance, the query results may be represented in tabular form having different columns. Since only the executable query is executed, the columns in the query results of the selected queries “QUERY 1” and “QUERY 2” must match up to provide a meaningful result. Therefore, the query results of the selected queries “QUERY 1” and “QUERY 2” be derived to use a common set of result columns for the query result of the executable query. Furthermore, if the INTERSECTION method is to be used, “QUERY 1” and “QUERY 2” cannot remain unaltered because the INTERSECTION statement requires that both queries have matching result columns. By default, this is the overlapping set of result columns with an optional addition of any more columns the user chooses to select. This overlapping set would then become the column set of the query result for the executable query. If the INTERSECTION method is being used, the overlapping set would also become the output columns for both selected queries “QUERY 1” and “QUERY 2”.

Illustrative SQL queries exemplifying “QUERY 1” and “QUERY 2” are shown in Tables I and II below. By way of illustration, the exemplary queries are defined SQL. However, any other language may be used to advantage.

TABLE I
EXEMPLARY SQL “QUERY 1”

| | |
|---|---|
| 001 | SELECT PID, Name, Age |
| 002 | FROM Demographic |
| 003 | WHERE Age > 50 |

TABLE II
EXEMPLARY SQL “QUERY 2”

| | |
|---|---|
| 001 | SELECT PID, Name, Sex |
| 002 | FROM Demographic |
| 003 | WHERE Sex = ‘M’ |

By way of example, the exemplary SQL query of Table I is defined to select information from “PID”, “Name” and “Age” columns (line 001) of a database table “Demographic” (line 002) for individuals having an Age (“Age>50”) of 50 years and more (line 003). The exemplary SQL query of Table II is defined to select information from “PID”, “Name” and “Sex” columns (line 001) of the database table “Demographic” (line 002) for individuals having as gender (“Sex”) ‘M’, i.e., male (line 003).

As was noted above, in one embodiment the query conditions of “QUERY 1” of Table I and “QUERY 2” of Table II would be logically combined and simplified through a process of Boolean algebra to determine the query condition(s) of a resultant query (i.e., the resultant query corresponding to region 530). An exemplary resultant SQL query which is determined by logically combining the query conditions of the exemplary queries “QUERY 1” and “QUERY 2” is shown in Table III below.

TABLE III
EXEMPLARY RESULTANT SQL QUERY

| | |
|---|---|
| 001 | SELECT PID, Name, Age, Sex |
| 002 | FROM Demographic |
| 003 | WHERE Age > 50 AND Sex = ‘M’ |

As can be seen from line 003 of Table III, the query condition of the exemplary resultant SQL query consists of the query conditions: (i) “AGE>50” of “QUERY 1” (Table I, line 003), and (ii) “Sex=‘M’” of “QUERY 2” (Table II, line 003), which are logically combined using a Boolean “AND” operator.

If the SQL INTERSECT statement is used as described above to merge query results obtained for the selected exemplary queries “QUERY 1” and “QUERY 2” into a single query result, the illustrative resultant INTERSECT query shown in Table IV below is obtained.

TABLE IV
EXEMPLARY RESULTANT INTERSECT QUERY

| | |
|---|---|
| 001 | SELECT PID, Name, Age, Sex |
| 002 | FROM Demographic |
| 003 | WHERE Age > 50 |
| 004 | INTERSECT |
| 005 | SELECT PID, Name, Age, Sex |
| 006 | FROM Demographic |
| 007 | WHERE Sex = ‘M’ |

As can be seen from Table IV, the exemplary resultant INTERSECT query consists of an intersection, “INTERSECT” (line 004), of “QUERY 1” (lines 001-003) and “QUERY 2” (lines 005-007). As was noted above, “QUERY 1” and “QUERY 2” have been modified to include matching result columns. More specifically, the SELECT statement of “QUERY 1” (line 001 of Table I) has been modified in Table IV (line 001) to include the “Sex” result column and the SELECT statement of “QUERY 2” (line 001 of Table II) has been modified in Table IV (line 005) to include the “Age” result column. Thus, “QUERY 1” and “QUERY 2” have matching result columns in the exemplary resultant INTERSECT query of Table IV (lines 001 and 005) which represent an overlapping result set of both queries.

In the example above, the query conditions of the selected queries “QUERY 1” and “QUERY 2” are logically combined to produce a resultant combination query that includes conditions for both QUERY 1 and QUERY 2. However, it is also contemplated that the resultant combination query may include conditions only from either QUERY 1 or QUERY 2. For example, it may be determined that the result set of QUERY 2 is wholly within the result set of QUERY 1 (i.e., the result set of QUERY 2 is a subset of the result set for QUERY 1). In this case, the resultant combination query would include conditions only from QUERY 1.

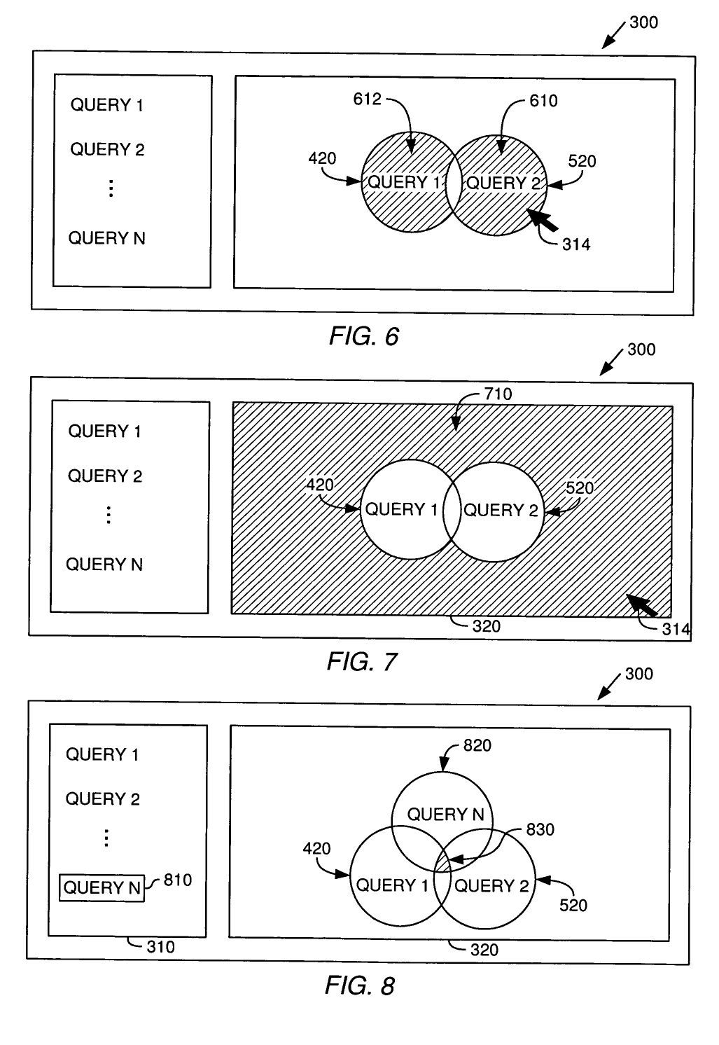

As was noted above, the user may select any user-selectable region, or regions, defined by the graphical objects and the representation area in the user interface 300. Examples illustrating selection of user-selectable regions other than the intersection of two selected queries are described below with reference to FIGS. 6-7.

Referring now to FIG. 6, the illustrative user interface 300 is shown after selection of a user-selectable region defined by the non-overlapping regions of the graphical objects 420 and 520. In other words, the selected region (shown hatched) only includes a portion 612 of the graphical object 420 and a portion 610 of the graphical object 520 (hereinafter referred to as the selected region 610-612). By way of example, the selected region 610-612 can be selected using the cursor 314. To this end, the user may click on both user-selectable regions 420 and 520. According to one aspect, this results in a selection of both graphical objects and the intersection thereof. Then, the user may deselect the intersection region of the user-selectable regions 420 and 520 by clicking thereon such that only the selected region 610-612 remains selected.

In the example of FIG. 6, query conditions of an executable query corresponding to the selected region 610-612 consist of two parts: (i) first query conditions specifying selection criteria for portion 612, and (ii) second query conditions specifying selection criteria for portion 610. Using Boolean operators, the first query conditions can be expressed as:
(Query conditions of QUERY 1) AND (NOT (Query conditions of QUERY 2))
   The second query conditions can be expressed as:
(NOT (Query conditions of QUERY 1)) AND (Query conditions of QUERY 2)
   The first and second query conditions are then logically combined using an OR operator to determine the query conditions of the executable query.

An exemplary resultant SQL query representing the selected region 610-612 which is determined by logically combining the query conditions of the exemplary queries “QUERY 1” (Table I) and “QUERY 2” (Table II) is shown in Table V below.

TABLE V
EXEMPLARY RESULTANT SQL QUERY

| | |
|---|---|
| 001 | SELECT PID, Name, Age, Sex |
| 002 | FROM Demographic |
| 003 | WHERE (Age > 50 AND Sex < > ‘M’) |
| | OR (Age <= 50 AND Sex = ‘M’) |

If the selected queries “QUERY 1” and “QUERY 2” are SQL queries, the executable query can be determined using the UNION and EXCEPT statements of the SQL set operations. In other words, in SQL the executable query can be expressed as:

QUERY 1) EXCEPT (QUERY 2)) UNION ((QUERY 2) EXCEPT (QUERY 1))

An exemplary resultant SQL query representing the selected region 610-612 which is determined using the UNION and EXCEPT statements is shown in Table VI below.

TABLE VI
EXEMPLARY RESULTANT UNION AND EXCEPT QUERY

| | |
|---|---|
| 001 | (SELECT PID, Name, Age, Sex |
| 002 | FROM Demographic |
| 003 | WHERE Age > 50 |
| 004 | EXCEPT |
| 005 | SELECT PID, Name, Age, Sex |
| 006 | FROM Demographic |
| 007 | WHERE Sex = ‘M’ |
| 008 | ) |
| 009 | UNION |
| 010 | (SELECT PID, Name, Age, Sex |
| 011 | FROM Demographic |
| 012 | WHERE Sex = ‘M’ |
| 013 | EXCEPT |
| 014 | SELECT PID, Name, Age, Sex |
| 015 | FROM Demographic |
| 016 | WHERE Age > 50 |
| 017 | ) |

Referring now to FIG. 7, the illustrative user interface 300 is shown after selection of a user-selectable region 710 that corresponds to the unoccupied region in the representation area 320. By way of example, the selected region 710 (shown hatched) can be selected using the cursor 314. Using Boolean operators, the query conditions of the executable query corresponding to the selected region 710 can be expressed as:
(NOT (Query conditions of QUERY 1)) AND (NOT (Query conditions of QUERY 2))

An exemplary resultant SQL query representing the selected region 710 which is determined by logically combining the query conditions of the exemplary queries “QUERY 1” (Table I) and “QUERY 2” (Table II) is shown in Table VII below.

TABLE VII
EXEMPLARY RESULTANT SQL QUERY

| | |
|---|---|
| 001 | SELECT PID, Name, Age, Sex |
| 002 | FROM Demographic |
| 003 | WHERE (Age <= 50 AND Sex < > ‘M’) |

If the selected queries “QUERY 1” and “QUERY 2” are SQL queries, the executable query can be determined using the UNION and EXCEPT statements of the SQL set operations. In other words, in SQL the executable query can be expressed as:
QueryALL EXCEPT ((QUERY 1) UNION (QUERY 2))
   where “QueryALL” represents a query that leads to a query result returning all queryable data represented by the representation area 320. For instance, this can be a query that selects the queryable data without any query conditions.

An exemplary resultant SQL query representing the selected region 710 which is determined using the UNION and EXCEPT statements is shown in Table VII below.

TABLE VIII
EXEMPLARY RESULTANT UNION AND EXCEPT QUERY

| | |
|---|---|
| 001 | SELECT PID, Name, Age, Sex |
| 002 | FROM Demographic |
| 003 | EXCEPT |
| 004 | (SELECT PID, Name, Age, Sex |
| 005 | FROM Demographic |
| 006 | WHERE Age > 50 |
| 007 | UNION |
| 008 | SELECT PID, Name, Age, Sex |
| 009 | FROM Demographic |
| 010 | WHERE Sex = ‘M’ |
| 011 | ) |

It should be noted that the user-selectable regions according to FIGS. 5-7 have been defined by only two graphical objects. However, in various embodiments the user may select more than two queries from the user-selectable queries. Thus, more than two graphical objects may be displayed in the representation area, whereby more user-selectable regions can be defined in the representation area. An exemplary embodiment illustrating selection of three queries is illustrated in FIG. 8.

Referring now to FIG. 8, the illustrative user interface 300 is shown after selection of still another query, i.e., query 810 “QUERY N” from the selection area 310. Accordingly, a graphical object 820 representative of the selected query 810 “QUERY N” is displayed in the representation area 320 together with the graphical objects 420 and 520. By way of example, the graphical objects 420, 520 and 820 are positionally related so that respective portions of the graphical objects 420, 520 and 820 are overlapping one another. Accordingly, the positionally related graphical objects 420, 520 and 820 define an overlapping region 830 and non-overlapping regions defined by the non-overlapping portions of the graphical objects 420, 520, 820 and the unoccupied region in the representation area 320.

While the foregoing is directed to embodiments of the present invention, other and further embodiments of the invention may be devised without departing from the basic scope thereof, and the scope thereof is determined by the claims that follow.

1. A method for composing a query, comprising:
displaying at least a first query object representative of a first query and a second query object representative of a second query in a user interface; and
positionally relating each of the query objects to define a plurality of user-selectable regions, each region corresponding to a different executable query.

2. The method of claim 1, wherein the query objects are geometric shapes.

3. The method of claim 1, further comprising, prior to displaying the query objects:
displaying a plurality of user-selectable queries in the user interface; and
receiving a user-selection of at least a first and a second user-selectable query, wherein the first query object is displayed for the first selected query and the second query object is displayed for the second selected query.

4. The method of claim 1, further comprising:
receiving a user-selection of one of the user-selectable regions;
determining an executable query corresponding to the selected region; and
executing the determined executable query.

5. The method of claim 4, wherein the first and second queries comprise respective query conditions and wherein determining the executable query comprises:
generating an aggregated condition by logically combining the query conditions using Boolean algebra on the basis of the selected region; and
generating the executable query on the basis of the aggregated condition.

6. The method of claim 4, wherein the first and second queries are SQL queries and wherein determining the executable query comprises:
generating the executable query by connecting the individual SQL queries using at least one of a SQL INTERSECT, a SQL UNION and a SQL EXCEPT statement.

7. The method of claim 4, wherein receiving the user-selection of the user-selectable region comprises:
detecting a cursor at a position corresponding to the selected region in the user interface; and
displaying a hover text message proximate the cursor, the hover text message describing the executable query corresponding to the selected region.

8. A method for composing a query, comprising:
displaying, in a user interface, at least a first graphical object and a second graphical object, each graphical object being representative of a different query; and
positionally relating each of the graphical objects so that respective portions of the graphical objects are overlapping one another, whereby a plurality of user-selectable regions is defined comprising (i) an overlapping region defined by the overlapping respective portions and (ii) non-overlapping regions defined by the non-overlapping portions of the graphical objects, and wherein each user-selectable region corresponds to a different executable query.

9. The method of claim 8, wherein the graphical objects are geometric shapes.

10. The method of claim 8, further comprising, prior to displaying the graphical objects:
displaying a plurality of user-selectable queries in the user interface; and
receiving a user-selection of at least a first and a second user-selectable query, wherein the first graphical object is displayed for the first selected query and the second graphical object is displayed for the second selected query.

11. The method of claim 8, further comprising:
receiving a user-selection of one of the user-selectable regions;
determining an executable query corresponding to the selected region; and
executing the determined executable query.

12. The method of claim 11, wherein the first and second queries comprise respective query conditions and wherein determining the executable query comprises:
generating an aggregated condition by logically combining the query conditions using Boolean algebra on the basis of the selected region; and
generating the executable query on the basis of the aggregated condition.

13. The method of claim 11, wherein the first and second queries are SQL queries and wherein determining the executable query comprises:
generating the executable query by connecting the individual SQL queries using at least one of a SQL INTERSECT, a SQL UNION and a SQL EXCEPT statement.

14. The method of claim 11, wherein receiving the user-selection of the user-selectable region comprises:
detecting a cursor at a position corresponding to the selected region in the user interface; and
displaying a hover text message proximate the cursor, the hover text message describing the executable query corresponding to the selected region.

15. A computer-readable medium containing a program which, when executed by a processor, performs a process for composing a query, the process comprising:
displaying at least a first query object representative of a first query and a second query object representative of a second query in a user interface; and
positionally relating each of the query objects to define a plurality of user-selectable regions, each region corresponding to a different executable query.

16. The computer-readable medium of claim 15, wherein the query objects are geometric shapes.

17. The computer-readable medium of claim 15, wherein the process further comprises, prior to displaying the query objects:
displaying a plurality of user-selectable queries in the user interface; and
receiving a user-selection of at least a first and a second user-selectable query, wherein the first query object is displayed for the first selected query and the second query object is displayed for the second selected query.

18. The computer-readable medium of claim 15, wherein the process further comprises:
receiving a user-selection of one of the user-selectable regions;
determining an executable query corresponding to the selected region; and
executing the determined executable query.

19. The computer-readable medium of claim 18, wherein the first and second queries comprise respective query conditions and wherein determining the executable query comprises:
generating an aggregated condition by logically combining the query conditions using Boolean algebra on the basis of the selected region; and
generating the executable query on the basis of the aggregated condition.

20. The computer-readable medium of claim 18, wherein the first and second queries are SQL queries and wherein determining the executable query comprises:
generating the executable query by connecting the individual SQL queries using at least one of a SQL INTERSECT, a SQL UNION and a SQL EXCEPT statement.

21. The computer-readable medium of claim 18, wherein receiving the user-selection of the user-selectable region comprises:
detecting a cursor at a position corresponding to the selected region in the user interface; and
displaying a hover text message proximate the cursor, the hover text message describing the executable query corresponding to the selected region.

22. A computer-readable medium containing a program which, when executed by a processor, performs a process for composing a query, the process comprising:
displaying, in a user interface, at least a first graphical object and a second graphical object, each graphical object being representative of a different query; and
positionally relating each of the graphical objects so that respective portions of the graphical objects are overlapping one another, whereby a plurality of user-selectable regions is defined comprising (i) an overlapping region defined by the overlapping respective portions and (ii) non-overlapping regions defined by the non-overlapping portions of the graphical objects, and wherein each user-selectable region corresponds to a different executable query.

23. The computer-readable medium of claim 22, wherein the graphical objects are geometric shapes.

24. The computer-readable medium of claim 22, wherein the process further comprises, prior to displaying the graphical objects:
displaying a plurality of user-selectable queries in the user interface; and
receiving a user-selection of at least a first and a second user-selectable query, wherein the first graphical object is displayed for the first selected query and the second graphical object is displayed for the second selected query.

25. The computer-readable medium of claim 22, wherein the process further comprises:
receiving a user-selection of one of the user-selectable regions;
determining an executable query corresponding to the selected region; and
executing the determined executable query.

26. The computer-readable medium of claim 25, wherein the first and second queries comprise respective query conditions and wherein determining the executable query comprises:
generating an aggregated condition by logically combining the query conditions using Boolean algebra on the basis of the selected region; and
generating the executable query on the basis of the aggregated condition.

27. The computer-readable medium of claim 25, wherein the first and second queries are SQL queries and wherein determining the executable query comprises:
generating the executable query by connecting the individual SQL queries using at least one of a SQL INTERSECT, a SQL UNION and a SQL EXCEPT statement.

28. The computer-readable medium of claim 25, wherein receiving the user-selection of the user-selectable region comprises:
detecting a cursor at a position corresponding to the selected region in the user interface; and
displaying a hover text message proximate the cursor, the hover text message describing the executable query corresponding to the selected region.

29. A graphical user interface residing in computer readable medium and configured for displaying a query composition user interface comprising:
a query representation display area configured for:
displaying at least a first graphical object and a second graphical object, each graphical object being representative of a different query; and
positionally relating the graphical objects so that respective portions of the graphical objects are overlapping one another, whereby a plurality of user-selectable regions is defined comprising (i) an overlapping region defined by the overlapping respective portions and (ii) non-overlapping regions defined by the non-overlapping portions of the graphical objects, and wherein each user-selectable region corresponds to a different executable query.

30. The graphical user interface of claim 29, wherein the graphical objects are geometric shapes.

31. The graphical user interface of claim 29, wherein the query composition user interface further comprises:
a query selection display area configured for:
displaying a plurality of user-selectable queries; and
allowing users to select at least a first and a second user-selectable query from the plurality of user-selectable queries, wherein the first graphical object in the query representation display area is displayed for the first selected query and the second graphical object is displayed for the second selected query.

32. The graphical user interface of claim 31, wherein the query composition user interface is further configured for allowing users to:
sequentially position a cursor over each of the first and second selected queries in the query selection display area;
drag each of the first and second selected queries to the query representation display area; and
drop each of the dragged first and second selected queries on the query representation display area to cause display of the first and second graphical objects.

33. The graphical user interface of claim 29, wherein the query representation display area is further configured for:
allowing a user to position a cursor over one of the user-selectable regions; and
displaying a hover text message proximate the cursor, the hover text message describing an executable query corresponding to the user-selectable region over which the cursor is positioned.

34. A graphical user interface residing in computer readable medium and configured for displaying:
a Venn diagram display area allowing users to manipulate at least a first geometrically shaped object representative of a first query and a second geometrically shaped object representative of a second query, wherein the objects are positionally related by user manipulation to define a plurality of user-selectable regions, each region corresponding to a different executable query.

35. The graphical user interface of claim 34, wherein the geometrically shaped objects are circles.

36. The graphical user interface of claim 34, further comprising:
a query selection display area configured for:
displaying a plurality of user-selectable queries; and
allowing users to select at least a first and a second user-selectable query from the plurality of user-selectable queries, wherein the first geometrically shaped object in the Venn diagram display area is displayed for the first selected query and the second geometrically shaped object is displayed for the second selected query.

37. The graphical user interface of claim 36, wherein the Venn diagram display area and the query selection display area are further configured for allowing users to:
sequentially position a cursor over each of the first and second selected queries in the query selection display area;
drag each of the first and second selected queries to the Venn diagram display area; and
drop each of the dragged first and second selected queries on the Venn diagram display area to cause display of the first and second geometrically shaped objects.

38. The graphical user interface of claim 34, wherein the Venn diagram display area is further configured for:
allowing a user to position a cursor over one of the user-selectable regions; and
displaying a hover text message proximate the cursor, the hover text message describing an executable query corresponding to the user-selectable region over which the cursor is positioned.
